(19) United States
(12) Patent Application Publication
(10) Pub. No.: US 2009/0070678 A1
(43) Pub. Date: Mar. 12, 2009

(54) SYSTEM AND METHOD FOR COLLECTING AND AGGREGATING INFORMATION

(75) Inventors: SERGEI R. LANDAR, Cambridge, MA (US); Tolga Oral, Winchester, MA (US)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/854,047

(22) Filed: Sep. 12, 2007

(51) Int. Cl. G06F 15/16; G06F 3/048

(52) U.S. Cl. 715/733; 709/206

(57) ABSTRACT

A method and computer program product for sending a meeting invitation to one or more meeting attendees and sending an information request to at least one of the one or more meeting attendees and a meeting host. An information request response is received from at least one of the one or more meeting attendees and the meeting host. A meeting profile is updated with information based upon, at least in part, the received information request response.

### TECHNICAL FIELD

This disclosure relates to collecting information and, more particularly, to collecting and aggregating information from meeting attendees for scheduled calendar meetings.

### BACKGROUND

Calendaring applications are widely used in enterprise work places for scheduling meetings and appointments. However, while calendaring applications easily facilitate collaboration, a meeting host must engage in a great deal of effort to collect, sort, and understand information in preparation of a scheduled meeting. For example, someone who is scheduling a meeting must first send out the meeting invitation to the various desired meeting attendees. Additionally, the person scheduling the meeting must follow-up with the various meeting attendees to ask questions, collect information and the like, in preparation for the meeting.

While a single email may be sent to all of the meeting attendees, for example, in the form of a group or mass emailing, each of the individual responses from the various attendees must be collected, and relevant information extracted. Then the collected information must be aggregated back into the calendar invite so that an updated meeting profile can be posted. The collection of information via email and integration of the information back into the meeting profile is a tedious and time consuming process that can become overwhelming, especially for large meeting having many invitees.

### SUMMARY OF DISCLOSURE

In a first implementation, a method includes sending a meeting invitation to one or more meeting attendees, and sending an information request to at least one of the one or more meeting attendees and a meeting host. An information request response is received from at least one of the one or more meeting attendees and the meeting host. A meeting profile is updated with information based upon, at least in part, the received information request response.

One or more of the following features may be included. Sending the information request may include sending the information request with the meeting invitation. Additionally, responding to the information request may be a requirement for accepting the meeting invitation. Additionally/alternatively, sending the information request may include sending the information request after sending the meeting invitation. Further, sending the information request may include sending the information request by at least one of the one or more meeting attendees to at least one of another meeting attendee and the meeting host.

Updating the meeting profile may include publishing the information based upon, at least in part, the received information request response in a calendar item associated with the meeting, the calendar item accessible by the meeting host. Additionally, the calendar item associated with the meeting may include a calendar item in a multi-user calendaring system, the calendar item accessible by the one or more meeting attendees and the meeting host. Updating the meeting profile may also include automatically updating the meeting profile in response to receiving the information request response. Additionally/alternatively updating the meeting profile may include updating the meeting profile in response to a user request. Further, updating the meeting profile may include providing statistical information based upon, at least in part, the received information request response.

According to another implementation, a computer program product resides on a computer readable medium and has a plurality of instructions stored thereon. When executed by a processor, the instructions cause the processor to perform operations including sending a meeting invitation to one or more meeting attendees, and sending an information request to at least one of the one or more meeting attendees and a meeting host. An information request response is received from at least one of the one or more meeting attendees and the meeting host. A meeting profile is updated with information based upon, at least in part, the received information request response.

One or more of the following features may also be included. The instructions for sending the information request may include instructions for sending the information request with the meeting invitation. Responding to the information request may be a requirement for accepting the meeting invitation. Additionally/alternatively, the instructions for sending the information request may include instructions for sending the information request after sending the meeting invitation. Further, the instructions for sending the information request may include instructions for sending the information request by at least one of the one or more meeting attendees to at least one of another meeting attendee and the meeting host.

The instructions for updating the meeting profile may include instructions for publishing the information based upon, at least in part, the received information request response in a calendar item associated with the meeting, the calendar item accessible by the meeting host. The calendar item associated with the meeting may include a calendar item in a multi-user calendaring system, the calendar item accessible by the one or more meeting attendees and the meeting host. The instructions for updating the meeting profile may include instructions for automatically updating the meeting profile in response to receiving the information request response. Additionally/alternatively, the instructions for updating the meeting profile may include instructions for updating the meeting profile in response to a user request. Further, the instructions for updating the meeting profile may include instructions for providing statistical information based upon, at least in part, the received information request response.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an information collection process, a calendar client application and a calendar server application coupled to a distributed computing network;

FIG. 2 is a diagrammatic view of a display screen rendered by the calendar client application and/or the calendar server application of FIG. 1;

FIG. 3 is a diagrammatic view of a display screen rendered by the calendar client application and/or the calendar server application of FIG. 1;

FIG. 4 is a flowchart of the information collection process of FIG. 1;

FIG. 5 is a diagrammatic view of a display screen rendered by the information collection process, the calendar client application and/or the calendar server application of FIG. 1;

FIG. 6 is a diagrammatic view of a display screen rendered by the information collection process, the calendar client application, and/or the calendar server application of FIG. 1;

FIG. 7 is a diagrammatic view of a display screen rendered by the information collection process, the calendar client application, and/or the calendar server application of FIG. 1; and

FIG. 8 is a diagrammatic view of a display screen rendered by the information collection process, the calendar client application, and/or the calendar server application of FIG. 1.

Like reference symbols in the various drawings indicate like elements.

### DETAILED DESCRIPTION OF THE PREFERRED EMBODIMENTS

### System Overview:

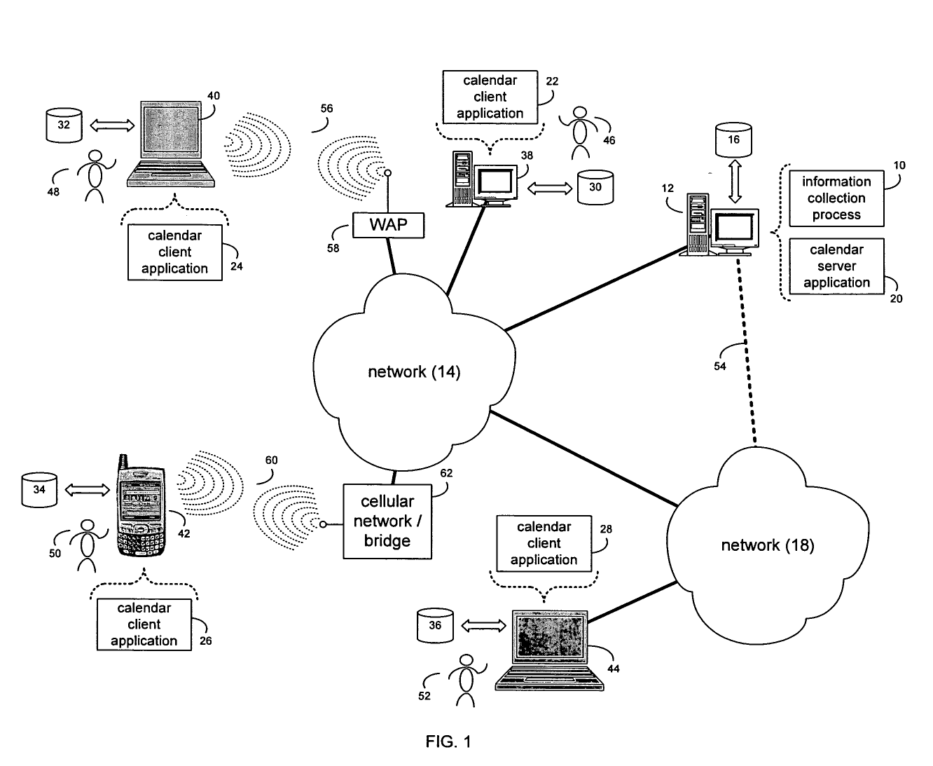

Referring to FIG. 1, there is shown information collection process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. In addition/as an alternative, information collection process 10 may reside on and may be executed by one or more client electronic devices, such as personal computer, a notebook computer, a personal digital assistant, and a data enable cellular phone, for example.

As will be discussed below in greater detail, information collection process 10 may send a meeting invitation to one or more meeting attendees, and may send an information request to at least one of the one or more meeting attendees and a meeting host. An information request response may be received from at least one of the one or more meeting attendees and the meeting host. A meeting profile may be updated with information based upon, at least in part, the received information request response.

The instruction sets and subroutines of information collection process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Various additional/alternative protocols and/or application servers may be used to allow access to server computer 12 via network 14. Network 14 may be connected to one or more secondary networks (e.g., network 18), examples of which may include but are not limited to: a local area network; a wide area network; or an intranet, for example.

Server computer 12 may execute calendar server application 20, examples of which may include but are not limited to Lotus Domino™ Server and Microsoft Exchange™ Server. Calendar server application 20 may be a messaging and collaboration software platform that may allow for user collaboration via calendar client applications 22, 24, 26, 28, examples of which may include but are not limited to Lotus Notes™ and Microsoft Outlook™. Information collection process 10 may be a stand alone application that interfaces with calendar server application 20 or an applet/application that is executed within calendar server application 20.

The instruction sets and subroutines of calendar server application 20, which may be stored on storage device 16 coupled to server computer 12 may be executed by one or more processors (not shown) and one or more memory architectures (not shown) incorporated into server computer 12.

As mentioned above, in addition/as an alternative to being a server-based application residing on server computer 12, the information collection process may be a client-side application (not shown) residing on a storage device (e.g., storage device 30, 32, 34, 36) coupled to one or more client electronic device 38, 40, 42, 44, respectively. As such, the information collection process may be a stand alone application that interfaces with a calendar client application (e.g., calendar client applications 22, 24, 26, 28), or may be an applet/application that is executed within a calendar client application. As such, the information collection process may be a client-side process, a server-side process, or a hybrid client-side/server-side process, which may be executed, in whole or in part, by server computer 12 and/or one or more of client electronic device 38, 40, 42, 44.

The instruction sets and subroutines of calendar client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of computing devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using calendar client applications 22, 24, 26, 28, users 46, 48, 50, 52 may access calendar server application 20 and may allow users to e.g., schedule in-person meetings, instant-message based meetings; web-based meetings; telephone conferences; and video conferences.

Users 46, 48, 50, 52 may access calendar server application 20 directly through the device on which the calendar client application (e.g., calendar client applications 22, 24, 26, 28) is executed, namely client electronic devices 38, 40, 42, 44, for example. Users 46, 48, 50, 52 may access calendar server application 20 directly through network 14 or through secondary network 18. Further, server computer 12 (i.e., the computer that executes calendar server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### The Information Collection Process:

For the following discussion, calendar client application 22, and to a lesser degree calendar client application 24, are going to be described for illustrative purposes. However, this is not intended to be a limitation of this disclosure, as other calendar client applications (e.g., calendar client applications 26, 28) may be equally utilized.

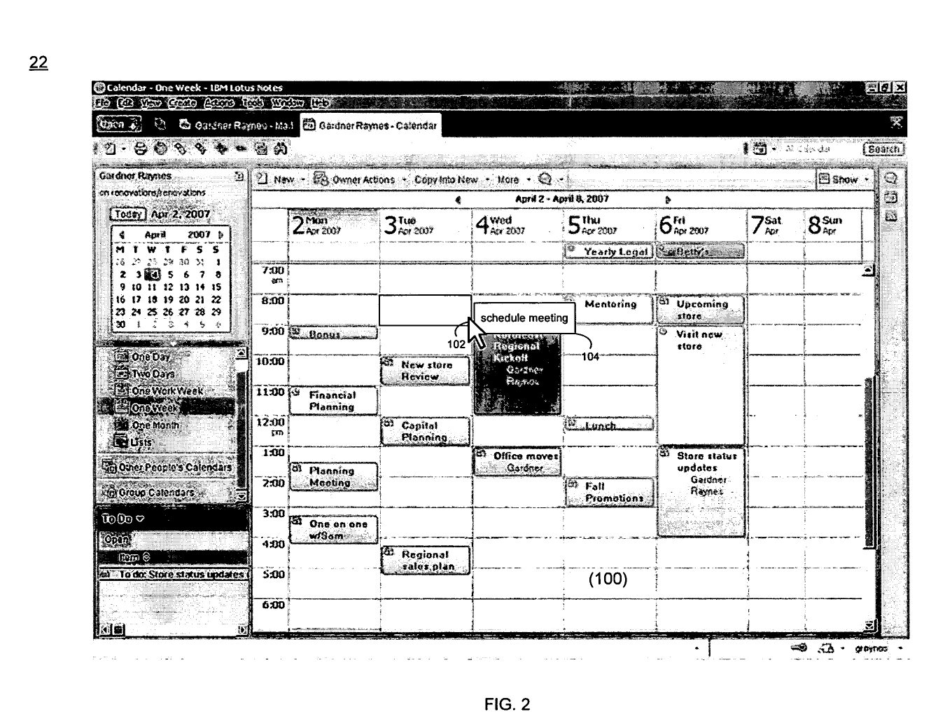

Referring also to FIG. 2, calendar client application 22 may allow user 46 to schedule meetings through a visual calendaring interface 100. Through visual calendaring interface 100, user 46 may schedule meetings with one or more users (e.g. user 48, user 50, user 52). When scheduling meetings, user 46 may select the time period for which the meeting is to be scheduled. For example, user 46 may select, via on-screen pointer 102 (which is controlled by a pointing device such as a mouse; not shown), the desired time period (e.g., 8:00-9:00 a.m. on Tuesday, 3 Apr. 2007). Once selected, user 46 may e.g. right-click the pointing device controlling on-screen pointer 102, resulting in calendar server application 20 and/or calendar client application 22 rendering pop-up window 104. While pop-up window 104 is shown to include only one option, namely “schedule meeting”, this is for illustrative purposes only and is not intended to be a limitation of this disclosure, as the number of options included within pop-up window 104 may be increased or decreased depending on the design criteria and user need.

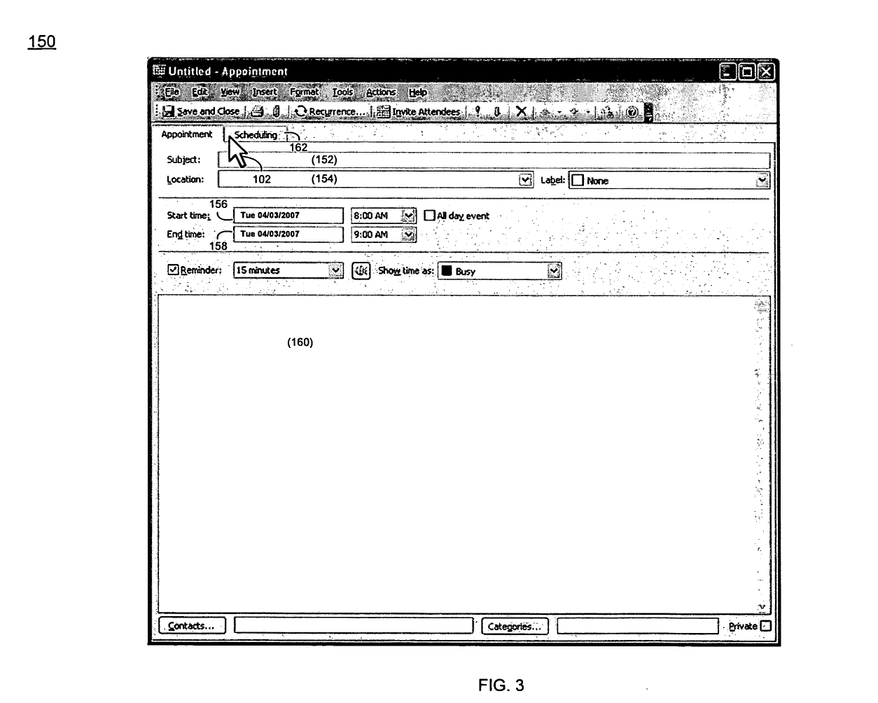

Referring also to FIG. 3 and upon selecting “schedule meeting” from pop-up window 104, calendar server application 20 and/or calendar client application 22 may render meeting window 150. Meeting window 150 may include a plurality of fields such as: the subject field 152 (which allows user 46 to define the subject of the meeting); location field 154 (which allows user 46 to define the location of the meeting); start time field 156 (which allows user 46 to define the start date/time of the meeting); end time field 158 (which allows user 46 to define the end date/time of the meeting); and meeting profile field 160 (which allows user 46 to define e.g. meeting requirements, meeting agenda, meeting related information, dial in information; web address information, and video conference information).

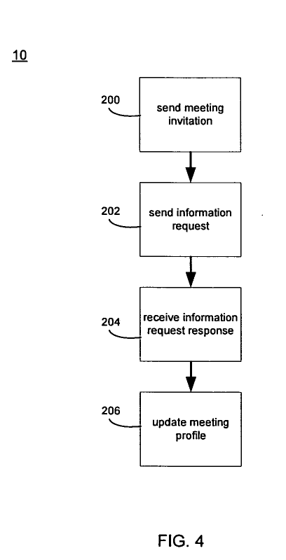

Referring also to FIG. 4 and as discussed above, information collection process 10, alone or in conjunction with calendar server application 20 and/or calendar client application 22, may allow user 46 to send 200 a meeting invitation to one or more meeting attendees (e.g., user 48, user 50, user 52). Information collection process 10 may also allow an information request to be sent 202 to at least one of the one or more meeting attendees (e.g., user 48, user 50, user 52) an a meeting host (e.g., user 46). Information collection process 10 may receive 204 an information request response (i.e., a response to the sent 202 information request). Information collection process 10 may further update the meeting profile field 160 with information based upon, at least in part, the received 204 information request response.

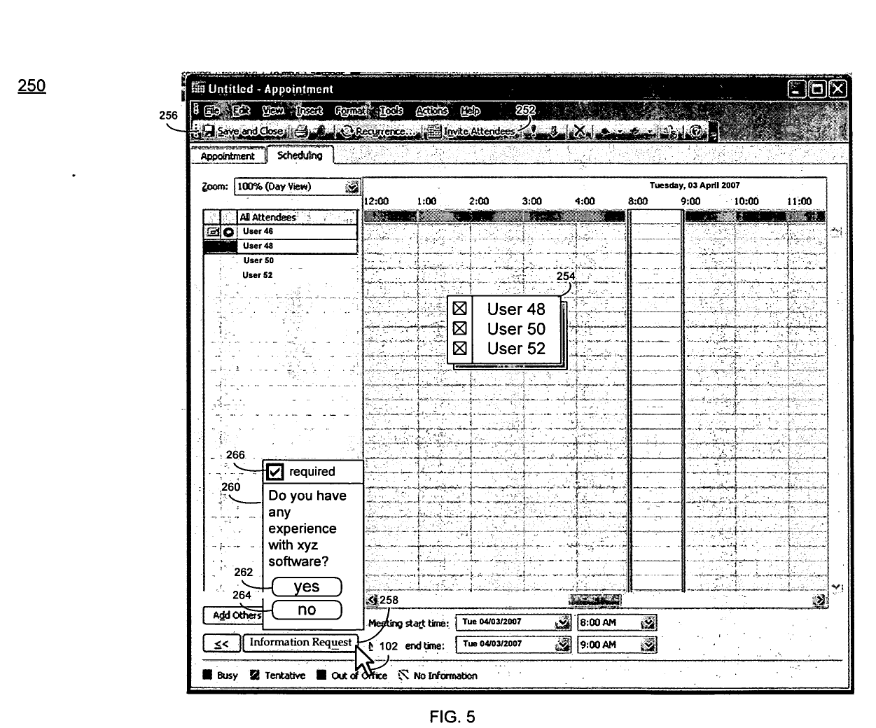

Continuing with the above-stated example, user 46 may select “scheduling” tab 162 in meeting window 150 using on-screen pointer 102. Once selected and referring also to FIG. 5, calendar server application 20 and/or calendar client application 22 may render scheduling window 250 which may allow user 46 to invite one or more meeting attendees (e.g. user 48, user 50, user 52) to the meeting being scheduled. Accordingly, by selecting the “invite attendees” button 252 using on-screen pointer 102, attendee window 254 may be rendered by calendar server application 20 and/or calendar client application 22 that allows user 46 to select one or more attendees for inviting to the meeting being scheduled. For illustrative purposes, scheduling window 250 is shown to have user 46, user 48, user 50, and user 52 invited to attend the meeting. Upon selecting “Save and Close” button 256, an invitation to the meeting scheduled by user 46 may be sent 200 to e.g., user 48, user 50, and user 52.

Sending 202 the information request may include sending 202 the information request with the meeting invitation. To send 202 the information request along with the meeting invitation, prior to sending 200 the invitation to the meeting (e.g., prior to selecting “Save and Close” button 256), user 46 may create an information request, e.g., by clicking on “Information Request” button 258 using on-screen pointer 102. Clicking on “Information Request” button 258 may result in information collection process 10, calendar server application 20, and/or calendar client application 22 rendering information request window 260. Using an input device (e.g., a keyboard; not shown) user 46 may input an information request (e.g., “Do you have any experience with xyz software?”) in information request window 260. The information request may include embedded response features (e.g., “yes” button 262, “no” button 264) allowing recipients (e.g., user 48, user 50, user 52) to provide an answer to the information request.

Information request window 260 may allow user 46 to create a custom information request. Additionally/alternatively, information request window may allow user 46 to select from one or more pre-formatted information request form (not shown). In this manner, user 46 may provide a custom information request or an information request based upon a stock information request form.

As in the illustrated example, the information request may be used to collect statistical information (namely, who has experience with xyz software). The information request may also be used to collect a variety of information (e.g., based upon a custom information request). Example of information that may be requested may include, but is not limited to, suggestions for meeting topics, anticipated time for accomplishing agenda items, opinions, and so on. As such, the present disclosure should not be construed as limited by the information requested.

Information collection process 10 may allow user 46 to make responding to the information request a requirement for accepting the meeting invitation. For example, information request window 260 may include “required” checkbox 266. User 46 may select (e.g., using on-screen pointer 102) “required” checkbox 266 to make responding to the information request necessary for accepting the meeting invitation. As such, in order for meeting attendees (e.g., user 48, user 50, user 52) to accept the meeting invitation, the meeting attendees must provide the requested information. Once user has input the requested information, user 46 may select “Save and Close” button 256 to send 200 the meeting invitation and to send 202 the information request along with the meeting invitation, as discussed above.

Similarly, information collection process 10 may make responding to the information request with one or more specific responses a requirement for accepting the meeting invitation. For example, the invitation may be an invitation to a function at which alcohol may be served. The information requested may be whether the meeting attendee is over the age of 21 (e.g., using an embedded response feature, such as yes/no buttons). Accepting the meeting invitation may require the meeting attendee to indicate that he is over the age of 21. The requirement for specific responses for accepting the meeting invitation may be applied to various other information requests, in a corresponding manner.

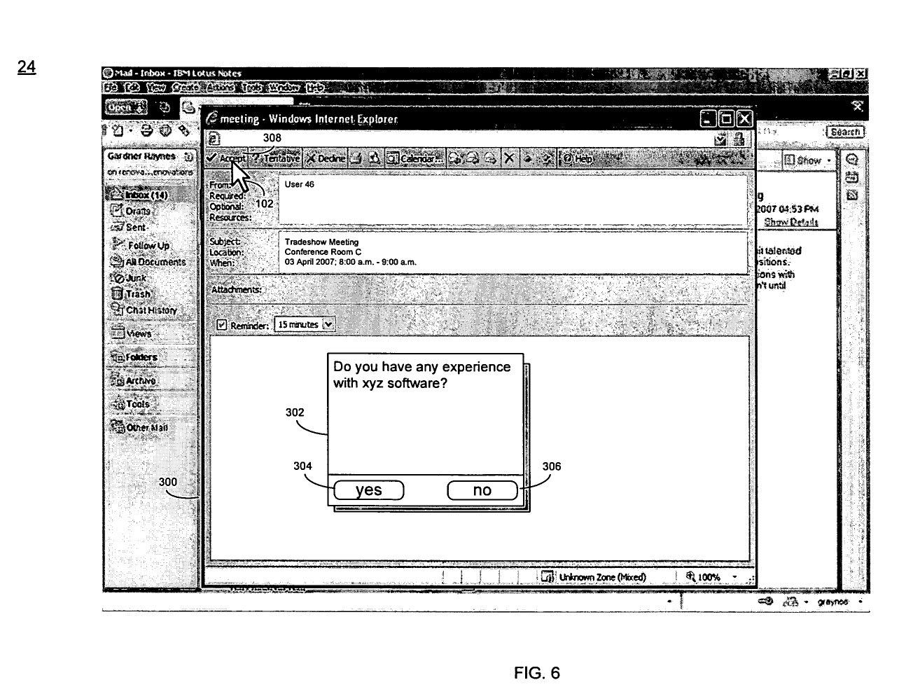

Referring also to FIG. 6, user 48, user 50, and user 52 may receive an email-based invitation to the meeting scheduled by user 46. For example, user 48 may receive invitation 300 (e.g., rendered by calendar server application 20 and/or calendar client application 24) in response to user 46 sending 200 invitations to the meeting that user 46 scheduled. Invitation 300 is shown to include a plurality of fields that define e.g. the sender of the email, whether or not attendance is required at the meeting, the location of the meeting, the date of the meeting, and the time of the meeting. Information collection window 302 may also be rendered (e.g., by one or more of information collection process 10, calendar server application 20, and/or calendar client application 24) in invitation 300. Information collection window 304 may include “yes” button 304 and “no” button 306 allowing user 48 to respond to the information request by selecting the applicable button. If the information request requires a text based response, information collection window 302 may include a text entry field (not shown) allowing user 48 to input a response (e.g., using a keyboard; not shown).

User 48 may review the meeting information and the information request. Once user 48 has responded to the information request (e.g., if a response is required for accepting the invitation), and if user 48 finds the meeting acceptable, may select “Accept” button 308 using on-screen pointer 102. Upon selecting “Accept” button 308, a response may be automatically generated and provided (e.g., via email) to user 46, acknowledging that user 48 plans on attending the meeting scheduled by user 46. Additionally, a notation (not shown) may be placed within visual calendaring interface 100 (of user 46) acknowledging that user 48 plans to attend the meeting.

Similarly, upon providing the requested information (e.g., by selecting one of “yes” button 304 or “no” button 306) information collection process 10 may receive 204 an information request response for user 48 Similar responses may be received 204 from other meeting attendees (if any) upon their providing the requested information.

In addition, or as an alternative, to sending 202 the information request along with the meeting invitation, information collection process 10 may allow a user to send 202 an information request after sending 200 the meeting invitation. For example, user 46 may be allowed to formulate and send 202 the information request after sending 200 the meeting invitation. The later-sent information request may be sent 202 before or after the one or more meeting attendees have accepted the meeting invitation. Further, user 46 may schedule the information request to be sent 202 at a predetermined time after the meeting invitation is sent 200, or at a predetermined time before the scheduled meeting time. For example, user 46 may host a monthly meeting. User 46 may schedule a recurring information request (e.g., soliciting suggested meeting agenda items) to be sent 202 one week before the monthly meeting. Various other alternatives may also be included.

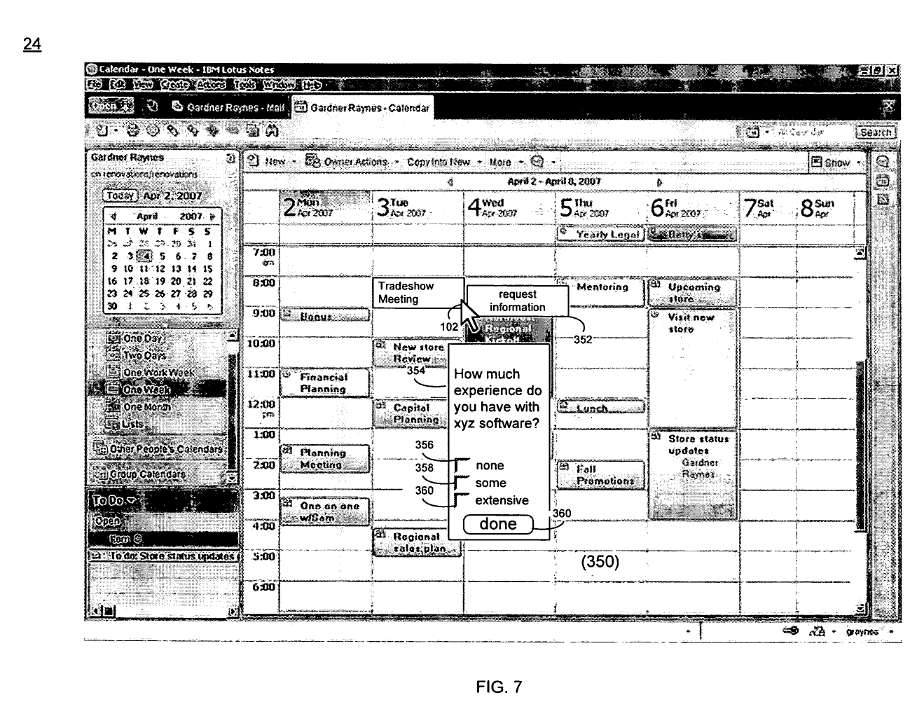

Additionally, information collection process 10 may allow such a later-sent information request to be sent by user 46 (the meeting host) and/or by one or more of the meeting attendees (e.g., user 48, user 50, user 52). Continuing with the above stated example, and referring also to FIG. 7 visual calendar interface 350 for user 48 (e.g., rendered by calendar server application 20 and/or calendar client application 24) may display the scheduled meeting (e.g., “Tradeshow Meeting” at 8:00 am, Tuesday, April 3^{rd}). User 48 may send 202 an information request regarding the “Tradeshow Meeting”. For example. User 48 may select, via on-screen pointer 102 (which is controlled by a pointing device such as a mouse; not shown), the scheduled “Tradeshow Meeting”. Once selected, user 48 may e.g. right-click the pointing device controlling on-screen pointer 102, resulting in information collection process 10, calendar server application 20 and/or calendar client application 24 rendering pop-up window 352. While pop-up window 352 is shown to include only one option, namely “request information”, this is for illustrative purposes only and is not intended to be a limitation of this disclosure, as the number of options included within pop-up window 352 may be increased or decreased depending on the design criteria and user need.

Selecting “request information” in pop-up window 352 may result in information collection process 10, calendar server application 20 and/or calendar client application 24 rendering information request window 354. User 48 may input (e.g., using a keyboard; not shown) the desired information request in information request window 354. For example, user 48 may input a follow-on information request related to the information request made by user 46 (namely “How much experience do you have with xyz software?”). Alternatively, user 48 may input an information request unrelated to any prior information request (if any). Similar to the information request from user 46, the information request from user 48 may include checkboxes (e.g., “none” checkbox 356, “some” checkbox 358, and “extensive” checkbox 360) allowing respondents to provide the requested information. Additionally/alternatively, user 48 may request information requiring a text based answer.

Once user 48 has input the desired information request in information request window 354, user 48 may click “done” button 362, resulting in information collection process 10 sending 202 the information request to the other meeting attendees (e.g., user 50, user 52) and the meeting host (e.g., user 46). In the foregoing examples, information collection process 10 has been described sending 202 the information request to all meeting attendees (e.g., to user 46, user 48, user 50, and user 52). Alternatively, a user formulating the information request may limit the information request to only a portion of the one or more meeting attendees and the meeting host. Appropriate user interface may be provided for controlling the intended recipients of the information request.

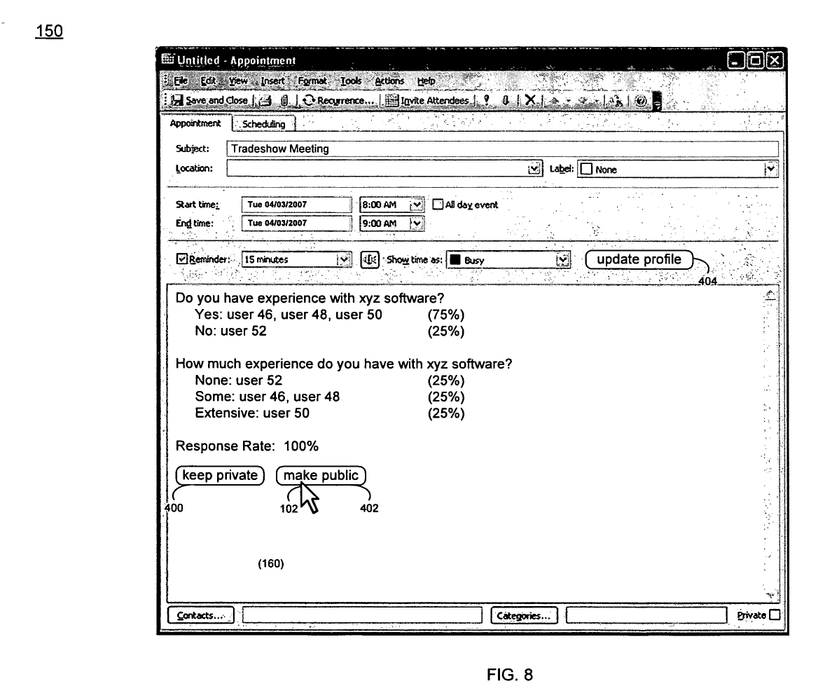

Information collection process 10 may received 204 information request responses from the one or more meeting attendees and the meeting host. Additionally, information collection process 10 may update 206 the meeting profile with information based upon, at least in part, the information request responses received 204 from the various meeting attendees (user 48, user 50, user 52) and the meeting host (user 46). Updating the meeting profile may include publishing the information based upon received 204 information request responses in a calendar item associated with the meeting. The calendar item may be accessible by the meeting host. For example, referring also to FIG. 8, calendar server application 20 and/or client calendar application 22 may render meeting window 150, including meeting profile field 160. As shown, meeting profile field 160 may display the information requests made by user 46 and by user 48. Additionally, meeting profile field 160 may include information based upon, at least in part, the information request responses received 204 by information collection process 10 from the various meeting attendees.

Further, information collection process 10 may update 206 the meeting profile with information based upon, at least in part, the information request responses received 204 from the various meeting attendees and filtered by the meeting host. For example, the meeting host may preview (e.g., in a preview window or user interface) the information request responses received 204 from the various meeting attendees prior to information collection process 10 updating 206 the meeting profile. The meeting host may select one or more received 204 information request responses (e.g., using the on-screen pointer). Information collection process 10 may update 206 the meeting profile based upon the selected one or more received 204 information request responses.

Information collection process 10 may allow the information in the updated 206 meeting profile (e.g., rendered in meeting profile field 160 of meeting window 150) to be kept private (e.g., by user 46 selecting “keep private” button 400), such that the results of the received 204 information request responses may only be known to user 46. Additionally/alternatively, user 46 may make the updated 206 meeting profile available to one or more other users by publishing the updated meeting profile in a calendar item associated with the meeting, in which the calendar item is accessible by one or more of the various meeting attendees (e.g., user 48, user 50, user 52). For example, user 46 may select “make public” button 402 using on-screen pointer 102. Further, publishing the updated meeting profile may include limiting the users who can view the updated meeting profile. For example, via a suitable interface, user 46 may make the updated meeting profile accessible to only a portion of the meeting attendees, e.g., user 48 and user 50. As such, while user 48 and user 50 may view the updated meeting profile, the updated meeting profile may not be accessible to user 52. Limited access to the updated meeting profile may be accomplished by way of various mechanisms (e.g., digital certificate, user specific access, password protection, etc.).

Updating 206 the meeting profile may also include automatically updating the meeting profile in response to receiving the information request response. For example, as information collection process 10 receives 204 information request responses from the various meeting attendees, information collection process 10 may automatically update the meeting profile. Alternatively, information collection process 10 may automatically update the meeting profile at predetermined intervals, e.g., whenever meeting window 150 is opened. In a related embodiment, updating 206 the meeting profile may include updating 206 the meeting profile in response to a user request. For example, information collection process 10 may update 206 the meeting profile in response to user 46 selecting “update profile” button 404 using on-screen pointer 102.

Further, updating 206 the meeting profile may include providing statistical information based upon, at least in part, the received 204 information request response. For example, as shown in meeting profile field 160 in FIG. 8, in addition to providing the various answers received 204 from the meeting attendees, information collection process 10 may update the meeting profile to include statistical information about the various responses, the response rate, and other information as appropriate. The statistical information may be updated as responses are received 204 from the various meeting attendees. Further, rather than displaying the raw data from the information request responses (e.g., which users have experience with xyz software), information collection process 10 may only display the statistical information based upon, at least in part, the information request responses received 204 from the various meeting attendees. Various other options may also be used.

A number of implementations have been described. Nevertheless, it will be understood that various modifications may be made. Accordingly, other implementations are within the scope of the following claims.

What is claimed is:

1. A method comprising:
sending a meeting invitation to one or more meeting attendees;
sending an information request to at least one of the one or more meeting attendees and a meeting host;
receiving an information request response from at least one of the one or more meeting attendees and the meeting host; and
updating a meeting profile with information based upon, at least in part, the received information request response.

2. The method of claim 1, wherein sending the information request includes sending the information request with the meeting invitation.

3. The method of claim 2, wherein responding to the information request is a requirement for accepting the meeting invitation.

4. The method of claim 1, wherein sending the information request includes sending the information request after sending the meeting invitation.

5. The method of claim 1, wherein sending the information request includes sending the information request by at least one of the one or more meeting attendees to at least one of another meeting attendee and the meeting host.

6. The method of claim 1, wherein updating the meeting profile includes publishing the information based upon, at least in part, the received information request response in a calendar item associated with the meeting, the calendar item accessible by the meeting host.

7. The method of claim 6, wherein the calendar item associated with the meeting includes a calendar item in a multi-user calendaring system, the calendar item accessible by the one or more meeting attendees and the meeting host.

8. The method of claim 1, wherein updating the meeting profile includes automatically updating the meeting profile in response to receiving the information request response.

9. The method of claim 1, wherein updating the meeting profile includes updating the meeting profile in response to a user request.

10. The method of claim 1, wherein updating the meeting profile includes providing statistical information based upon, at least in part, the received information request response.

11. A computer program product residing on a computer readable medium having a plurality of instructions stored thereon which, when executed by a processor, cause the processor to perform operations comprising:
sending a meeting invitation to one or more meeting attendees;
sending an information request to at least one of the one or more meeting attendees and a meeting host;
receiving an information request response from at least one of the one or more meeting attendees and the meeting host; and
updating a meeting profile with information based upon, at least in part, the received information request response.

12. The computer program product of claim 11, wherein the instructions for sending the information request include instructions for sending the information request with the meeting invitation.

13. The computer program product of claim 12, wherein responding to the information request is a requirement for accepting the meeting invitation.

14. The computer program product of claim 11, wherein the instructions for sending the information request include instructions for sending the information request after sending the meeting invitation.

15. The computer program product of claim 11, wherein the instructions for sending the information request include instructions for sending the information request by at least one of the one or more meeting attendees to at least one of another meeting attendee and the meeting host.

16. The computer program product of claim 11, wherein the instructions for updating the meeting profile include instructions for publishing the information based upon, at least in part, the received information request response in a calendar item associated with the meeting, the calendar item accessible by the meeting host.

17. The computer program product of claim 16, wherein the calendar item associated with the meeting includes a calendar item in a multi-user calendaring system, the calendar item accessible by the one or more meeting attendees and the meeting host.

18. The computer program product of claim 11, wherein the instructions for updating the meeting profile include instructions for automatically updating the meeting profile in response to receiving the information request response.

19. The computer program product of claim 11, wherein the instructions for updating the meeting profile include instructions for updating the meeting profile in response to a user request.

20. The computer program product of claim 11, wherein the instructions for updating the meeting profile include instructions for providing statistical information based upon, at least in part, the received information request response.
